(19) United States
(12) Patent Application Publication
(10) Pub. No.: US 2015/0332368 A1
(43) Pub. Date: Nov. 19, 2015

(54) SYSTEM AND METHOD FOR ASSISTING IN LOCATING AND CHOOSING A DESIRED ITEM IN A STORAGE LOCATION

(71) Applicant: SCA HYGIENE PRODUCTS AB, Göteborg (SE)

(72) Inventors: Kent VARTIAINEN, Lerum (SE); Shadi STÅHL, Mölndal (SE)

(73) Assignee: SCA Hygiene Products AB, Goteborg (SE)

(21) Appl. No.: 14/654,299

(22) PCT Filed: Dec. 21, 2012
(86) PCT No.: PCT/SE2012/051484

§ 371 Date: Jun. 19, 2015

(51) Int. Cl. G06Q 30/06; G06K 9/00; G06Q 50/00; G06F 17/30; G06Q 30/02

(52) U.S. Cl. CPC G06Q 30/0623; G06F 17/30867; G06F 17/30598; G06Q 30/0282; G06Q 50/01; G06K 9/00671

(57) ABSTRACT

A computer-based system and a method for providing product-related information to a user regarding at least one desired item are described. The item is a hygiene article. The computer based system includes a first computer server being connectable to at least one social network for providing social networking information, in the form of feedback and opinions related to the item, from members of the social network, a second computer server being connectable to at least one mobile device arranged for entering information identifying the desired item and arranged for presenting the product-related information to the user; and a memory unit arranged for storing the social networking information and arranged to be accessed by the first server and the second server. The second server includes a filtering unit arranged for filtering data retrieved by the first server in order to supply the product-related information to the mobile device.

### TECHNICAL FIELD

The present disclosure relates to a computer-based system for providing product-related information to a user regarding at least one desired item, wherein the item is a hygiene article, such as a male or female incontinence protector, a sanitary pad, a diaper with tape fastener, a pant diaper or a belted diaper, a lotion, wipe or towel.

### BACKGROUND ART

Today, it is common that shops such as retail markets, supermarkets and other stores sell a large variety of products and goods which are arranged and put on display on shelves forming aisles in said shops.

Large supermarkets, in particular, may offer a very large number of similar products from different suppliers or even similar products but with a small difference in usage from the same supplier. For this reason, it can sometimes be very difficult for the consumer to locate and to choose which product to buy in such a vast selection of products on display.

In particular, in some areas and for certain types of goods, it can be difficult for a consumer in a supermarket, for example, to actually distinguish between different, but similar, products within a particular product category.

One particular field of products in which it can be particularly difficult for a consumer to actually locate and choose between different brands or selections of a desired product is the field of hygiene products, especially in the form of absorbent articles. Such articles are marketed in the form of feminine hygiene products such as sanitary pads, or alternatively baby products such as diapers, or alternatively incontinence products for both women and men or alternatively wipes or towels. Hygiene products which are not absorbent, such as lotions, are also a type of product where it is difficult for the consumer to choose between the available selections. The consumer often needs additional information about these types of hygiene products; about how they are used and which product serves best at certain needs. All these types of products can, at first sight, be quite similar in the way they are packaged, marketed and sold. The product names of hygiene products can also be difficult to distinguish from one another. Also, all these types of products may be positioned in generally the same area of a supermarket.

In the case of incontinence products for men and women, there is a large variety of products and the users would greatly benefit from any information that would help in the decision-making, apart from information relating to manufacturer and product-specific details. However, there is also a need for discretion since there are many users of this type of product who are embarrassed about needing to use them.

In summary, a consumer of a hygiene product may be faced with a vast range of manufacturers and types of products which are similar in usage and functionality but not the same regarding e.g. size, fit and performance. All these products may come in similarly designed packages and with similar product names, which can be confusing for the consumer. Consequently, the assortment of products within this field may appear to be complicated and difficult to comprehend for the customer.

It is understood that it is difficult for the consumer to understand and grasp the whole range of hygiene products being on the market today. Sometimes, a consumer who comes into a supermarket may know exactly which product to choose, but often the customer needs assistance for choosing a suitable product.

It is previously known to use modern computer-based systems for assisting a user, for example a customer in a supermarket, in finding a particular product. The patent document US 2010/0013662, for example, relates to a product locating system using RFID devices which are positioned on a particular product or on a shelf on which the product is positioned. The customer can enter information regarding a product description on a fixed computer terminal in the supermarket and the RFID device will subsequently return a signal to the computer terminal which indicates the position of the product in question.

Furthermore, the patent document US 2012/0023034 discloses a system for locating merchandise in a store, wherein the products in the store are provided with location indicators. The customers in the store may find the products by accessing a database in which information regarding the location of the products is stored.

The patent application US 2011/0276385 discloses an apparatus and a method for locating a user's wireless device in a store and giving product information to the user based on a product search done by the user, a purchase history and the device's physical location in the store. The location of the device is calculated with for example triangulation and the user receives product information depending on where in the store he/she is located.

Although the above-mentioned methods are related to aiding a user such as a customer in a store in finding desired products and obtaining information about them, they are unnecessarily complex and can be perceived as difficult to use for the customer. Consequently, there is a need for improved systems and methods which are easy to use and which give clear and useful information for assisting a customer in locating and choosing items such as hygiene products in a supermarket or similar storage location. In particular, there is a need for today's customers to find guidance regarding suitable products within a particular product type or from a particular producer. There is also a need for providing additional information which helps in the choice making besides manufacturer and product specifications because of the sensitive nature of some items.

### SUMMARY OF THE-DISCLOSURE

Consequently, it is an object of the present disclosure to solve the above-mentioned problem and to provide a system and a method which can be used to assist for example the user of a particular desired product, for example an absorbent product, in order to locate that particular product in a storage location, for example a supermarket, a warehouse or similar, to be supplied with suitable information regarding other products which can be available of a particular type or from a certain producer and also to be supplied with information with for example usage experiences, advice or tips from other users of the particular product type. It is also an object of the disclosure to provide a system and a method by means of which a consumer can be assisted in finding and choosing among suitable alternatives to a particular desired product or product type in case such a product or product type is not available in the location in question.

In particular, it is an object of the present disclosure to provide a system and a method which are easy to use and which can give a user clear information on a mobile device regarding the desired product, and suitable alternative products, in said storage location.

Yet another object of the disclosure is to provide a system and a method that facilitate, for users of a product, such as an absorbent hygiene product, to retrieve product-related information in addition to finding the location of said product. In addition to product information the user will receive information with experiences from users who have used the products before and it may also contain tips and advice from those users to assist the user in choosing which product to buy. It is a particular object to provide such product information (relating for example to user experiences) taking into account that many users of certain absorbent products, such as incontinence products, may feel slightly embarrassed about using such products and consequently may hesitate in announcing openly that they are users of such products. In other words, it is desirable that it handle such user-related information in a discreet and confidential manner.

According to a first aspect of the present disclosure, it relates to a computer-based system for providing product-related information to a user regarding at least one desired item. The item is a hygiene article, such as a male or female incontinence protector, a sanitary pad, a diaper with tape fastener, a pant diaper or a belted diaper; a lotion, wipe or towel. The computer-based system comprises:

a first computer server being connectable to at least one social network for providing social networking information, in the form of feedback and opinions related to said item, from members of said social network, a second computer server being connectable to at least one mobile device arranged for entering information identifying said desired item and arranged for presenting said product-related information to said user; a memory unit arranged for storing said social networking information and arranged to be accessed by the first server and the second server.

User information regarding specific items may be obtained when having a first computer server that is connectable to at least one social network. In social networks it may be possible for users of the network to express opinions and experiences about certain products. It may also be possible for users to rate products. The information may then be accessed and collected by the first computer server. The second computer server is connected to the mobile device to provide it with the obtained information. For example, the items location and product related information may be shown on the mobile device which makes the information easily accessed for the user.

The system further comprises that said second server comprises a filtering unit arranged for filtering data retrieved by said first server in order to supply said product-related information to said mobile device and wherein said mobile device comprises an image capturing device arranged for capturing at least one image or video sequence or live video feed and arranged for recognizing any occurrence of said desired item within said captured image or video sequence or live video feed.

An advantage with having a second server which filters data retrieved by the first server is that user discretion may be provided. Especially when handling user information regarding incontinence products for men and women many users will want to remain anonymous so the filtering of data is in order to provide for user discretion. Another advantage with the filtering is that the most relevant information to send to the user can be filtered out and sent. When choosing between items in a store, user information regarding things such as an items use, quality, priceworthiness, a consumer rating of the item and user advice may be provided to the customer to help in deciding which product to buy.

An advantage with that the mobile device may capture an image or a video representing a point of sale and that it is arranged for recognizing any occurrence of said desired item within said captured image or video sequence or live video feed is that when a customer uses his/her mobile device to capture an image or a video of a shelf with products in a store, the mobile device may provide information regarding the recognized items. In addition to receiving the information discussed above, the customer may obtain information regarding available alternatives in case an originally desired product is out of stock or if it is not available or if it cannot be found by the customer.

The system may further comprise that the filtering unit is arranged for said filtering based on a predetermined set of criteria related to the desired item, including at least one of the following: social networking information comprising feedback and opinions from said members relating to said desired item; categories or groups of products in which said item can be classified; points of sale or locations at which said desired item can be purchased by the user; information regarding the availability of said desired item at said points of sale or locations; information regarding criteria relating to said desired item such as its price, its manufacturer, product type, usage, size, colour, features or similar; and information regarding products which are alternatives to said desired item.

An effect of having a filtering unit is, as discussed above, that user discretion may be ensured, reducing possible embarrassment for members of the social networks. The user may also predetermine what kind of information is considered most interesting and thus the information provided to the user is customized.

The system may further comprise that the memory unit comprises a vendor database comprising information relating to said points of sale or locations and the availability of the desired item.

An advantage with having a vendor database with information is that it may be possible for a user to check the availability of a product before actually going to the store or sales location. The user may also be informed before going to the store whether there are any suitable alternatives if the desired item is not available. Another advantage with having a vendor database is that the information sent to the user may be complimented with information regarding products directly from the vendor.

The system may further comprise that the mobile device is arranged for allowing input of user information in the form of a shopping list comprising a plurality of desired items.

An advantage with the mobile device being arranged for allowing input of user information is that the user may make lists of desired items which the system can use when finding information about the desired items. The system may prioritise providing information about the items on the list. The system may also warn the user that certain stores do not have an item on the list if that is the case.

The system may further comprise a mobile device which comprises a display arranged for presenting said product-related information.

The effect of having a display arranged for presenting the product-related information is that the user will be able to see the information as soon as the mobile device receives it; the information is made easily accessible for the user. The user may then base his/her choice of product on the information presented on the display.

The system may further comprise that the mobile device is arranged for presenting information related to the location of said desired item by superimposing a graphical representation of information related to the location of said desired item onto the displayed image or video sequence on said display.

An effect of this is that the image or video captured by the user representing the point of sale or location may be used when displaying information related to the location of said desired item. The location may be graphically represented in the image or video which makes it easy for the user when comparing the location data in the captured image or video to the actual point of sale in the store.

The system may further comprise that the mobile device is arranged for recognizing the occurrence of the desired item through the use of a recognition graphic in the form of a design, print, marking, code or similar applied to the item or its packaging.

An effect of this is that several things may be used to recognize an item. The mobile device may try to recognize items by trying several different recognition graphics. If, for example, the recognition graphic recognizing specific design fails, recognition by a specific code may work to recognize it. It may then be possible to recognize items even if they are partly hidden; only part of the item must be visible.

According to a second aspect of the present disclosure, it relates to a method for providing product-related information to a user regarding at least one desired item. The item is a hygiene article, such as a male or female incontinence protector, a sanitary pad, a diaper with tape fastener, a pant diaper or a belted diaper; a lotion, wipe or towel. The method comprises: connecting a first computer server to at least one social network for providing social networking information, in the form of feedback and opinions related to said item, from members of said social network; connecting a second computer server to at least one mobile device arranged for entering information identifying said desired item and arranged for presenting said product-related information to said user; storing said social networking information in a memory unit; providing access to said memory unit by the first server and the second server.

As discussed before, an advantage with having a first computer server that is connectable to at least one social network is that user information regarding specific items may be obtained. In social networks it may be possible for users of the network to express opinions and experiences about certain products. It may also be possible for users to rate products. The information may then be accessed and collected by the first computer server. The second computer server is connected to the mobile device to provide it with the obtained information. For example, the items location and product related information may be shown on the mobile device which makes the information easily accessed for the user.

The method further comprises the steps of: capturing at least one image or video sequence or live video feed by means of an image capturing device in said mobile device, recognizing any occurrence of said desired item within said captured image or video sequence or live video feed, filtering data retrieved by said first server in a filtering unit forming part of said second server and supplying said product-related information to said mobile device.

The fact that the method comprises capturing an image or a video representing a point of sale and recognizing any occurrence of said desired item within said captured image or video sequence or live video feed means that when a customer uses his/her mobile device to capture an image or a video of a shelf with products in a store, the mobile device may provide information regarding the recognized items. The customer may also obtain information regarding available alternatives, which alternatives have also been recognized in the captured image or video sequence, in case an originally desired product is out of stock or if it is not available or if it cannot be found by the customer.

An advantage with filtering data in the second server which has been retrieved by the first server is that user discretion may be provided. Especially when handling user information regarding incontinence products for men and women many users will want to remain anonymous so the filtering of data is in order to provide for user discretion. Another advantage with the filtering is that the most relevant information to send to the user can be filtered out and sent. When choosing between items in a store, user information regarding things such as an items use, quality, priceworthiness, a consumer rating of the item and user advice may be provided to the customer to help in deciding which product to buy.

The method may further comprise filtering based on a predetermined set of criteria related to the desired item, including at least one of the following: social networking information comprising feedback and opinions from said members relating to said desired item; categories or groups of products in which said item can be classified; points of sale or locations at which said desired item can be purchased by the user; information regarding the availability of said desired item at said points of sale or locations; information regarding criteria relating to said desired item such as its price, its manufacturer, product type, usage, size, colour, features or similar; and information regarding products which are alternatives to said desired item.

An effect of filtering based on a predetermined set of criteria related to the desired item is, as discussed above, that user discretion may be ensured. Another advantage is that the user may predetermine what kind of information is considered most interesting and thus the information provided to the user is customized.

The method may further comprise providing information relating to said points of sale or locations and the availability of the desired item via a vendor database forming part of said memory unit.

An advantage with providing information via a vendor database which forms part of the memory unit is that it may be possible for a user to check the availability of a product before actually going to the point of sale or location. The user may also be informed before going to the store whether there are any suitable alternatives if the desired item is not available. Another advantage with having a vendor database is that the information sent to the user may be complimented with information regarding products directly from the vendor.

The method may further comprise presenting said product-related information on a display forming part of said mobile device.

The effect of presenting the product-related information on a display is that the user will be able to see the information as soon as the mobile device receives it. The user may then base his/her choice of product on the information presented on the display.

The method may further comprise presenting information related to the location of said desired item, by superimposing a graphical representation of information related to the location of said desired item onto the displayed image or video sequence on said display.

An effect of superimposing a graphical representation of information related to the location of the desired item is that it will be easy for the user do see and interpret the information on his/her display. The location may be graphically represented on the image or video which makes it easy for the user when comparing the location data in the captured image or video to the actual point of sale in the store.

The method may further comprise recognizing the occurrence of the desired item through the use of a recognition graphic in the form of a design, print, marking, code or similar applied to the item or its packaging.

An effect of this is that several things may be used to recognize an item. The mobile device may try to recognize items by trying several different recognition graphics. If, for example, the recognition graphic recognizing specific design fails, recognition by a specific code may work to recognize it. It may then be possible to recognize items even if they are partly hidden; only part of the item must be visible.

According to a third aspect of the present disclosure, it relates to a computer program for providing product-related information to a user regarding at least one desired item.

The computer program may further comprise that when it is executed by a processor, it causes a computer system comprising a first server, a second server and a mobile device to perform the method according to above.

An effect of having a computer program which performs the method according to above is that it can be installed and used on mobile devices. Mobile devices are easy for the users/customers to bring anywhere and most people always have at least one mobile device with them.

According to a fourth aspect of the present disclosure, it relates to a mobile device for providing product-related information to a user regarding at least one desired item. The mobile device comprises a processor and a storage medium for storing computer programs executable by said processor.

The mobile device may further comprise that it is arranged for operating in accordance with a computer program as defined above.

An effect of having a mobile device arranged to operate in accordance with a computer program as defined above is that the method may be used anywhere with a mobile device.

### BRIEF DESCRIPTION OF DRAWINGS

The disclosure will be described below with reference to an embodiment and the appended drawings, in which:

FIG. 1 illustrates the computer based system in connection with social networks and users.

FIG. 2 illustrates a block diagram of the method for providing product-related information to a user.

FIG. 3 illustrates an additional block in the block diagram of FIG. 2.

FIG. 4 illustrates an additional block in the block diagram of FIG. 2.

FIG. 5 illustrates an additional block in the block diagram of FIG. 2.

FIG. 6 illustrates an additional block in the block diagram of FIG. 2.

FIG. 7 shows a mobile device comprising an image capturing device.

FIG. 8 shows a mobile device displaying a captured image.

FIG. 9 shows a mobile device displaying a captured image with a graphical representation of a desired or an alternative item.

### DETAILED DESCRIPTION OF EMBODIMENTS

Embodiments of the present disclosure will be described more fully hereinafter with reference to the accompanying drawings, in which embodiments of the-disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

Certain aspects of the present disclosure will be exemplified using a mobile communication device. However, it should be appreciated that the disclosure is as such equally applicable to electronic devices in general which have a display and an image/video capturing device. Examples of such devices may for instance be any type of mobile phone, laptops (such as standard, ultra portables, netbooks, micro laptops, and pads), handheld computers, PDAs, gaming devices, accessories to mobile phones, etc. However, for the sake of clarity and simplicity, the embodiments outlined in this specification are only exemplified with and related to mobile communication devices hereinafter referred to as mobile devices. The terms “product” and “item” are used interchangeably throughout the document and refers to products/items in stores and products/items that a user of the disclosure may be interested in buying. Also the terms “user” and “customer” are used interchangeable and refers to the person using the system, method and mobile device of the disclosure.

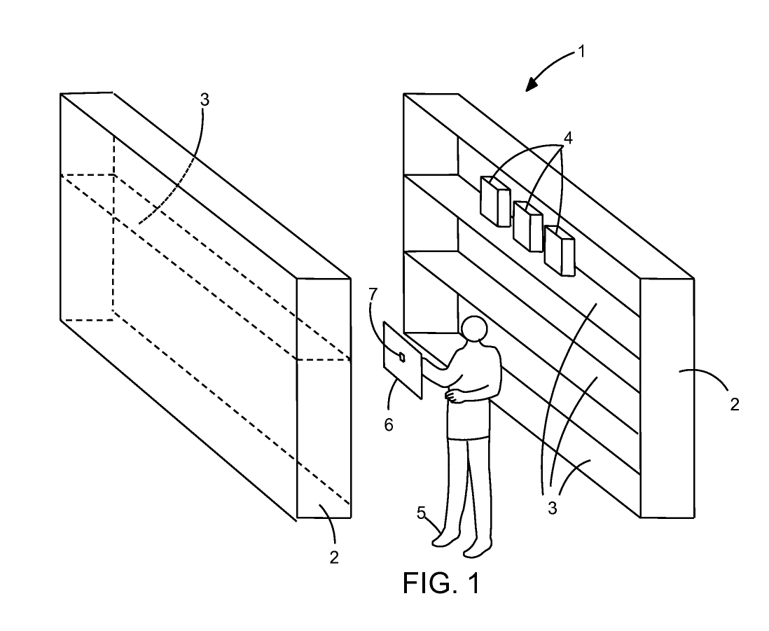

FIG. 1 illustrates a computer-based system 1 for providing product-related information to a user 2 regarding at least one desired item which is a hygiene article; such as a male or female incontinence protector, a sanitary pad, a diaper with tape fastener, a pant diaper or a belted diaper; a lotion, wipe or towel.

The computer-based system 1 of FIG. 1 comprises a first computer server 3 being connectable to at least one social network 4 for providing social networking information. The first computer server 3 may be connected to the at least one social network 4 via internet. The first computer server 3 may collect the social networking information from the at least one social network 4 via internet by connecting to the servers of the at least one social network 4 and downloading the information. The information may be sent to the first computer server 3 by the providers of the at least one social network 4. The social networking information is in the form of feedback and opinions related to said item from members 5 of said social network 4. In social networks 4 it may be possible for members 5 of the network 4 to express opinions and experiences about certain products. It may also be possible for members 5 to rate products. The social network information may comprise opinions and experiences related to the item. The social network information may comprise ratings of the item by members 5. The social network information may comprise usage experiences of the item. The social network information may comprise tips regarding the item. The social network may be any kind of social network, such as a member forum for a specific topic. Such a forum may for example be the Global Forum on Incontinence, which relates to specific absorbent products, or a forum such as Facebook, which is a more general-purpose social network.

The computer-based system 1 of FIG. 1 further comprises a second computer server 6 being connectable to at least one mobile device 7 arranged for entering information identifying said desired item and arranged for presenting said product-related information to said user 2. The second computer server 6 exchanges data with the mobile device 7 with for example the IP (Internet Protocol). The second computer server 6 is connected to the mobile device to provide it with the information obtained in the first computer server 3. The mobile device 7 may also provide the second computer server 6 with what information the user 2 wants and regarding what items.

The computer-based system 1 of FIG. 1 further comprises a memory unit 8 arranged for storing said social networking information. When storing the information, there is no need for the first server 3 to collect the social network information over and over again when a mobile device requests the information. When storing the information, the first server 3 only needs to collect updates to the information from the at least one social network 4. The memory unit 8 is further arranged to be accessed by the first server 3 and the second server 6. Since the first server 3 and the second server 6 and the memory unit 8 are all part of the computer based system 1, they are part of the same unit and may be connected directly to each other. The memory unit may be any type of memory, for example a RAM, a flash memory, a ROM or any type of memory capable of storing data.

The system 1 of FIG. 1 may further be arranged so that said second server 6 comprises a filtering unit 9 arranged for filtering data retrieved by said first server 3 in order to supply said product-related information to said mobile device 7. All social network information retrieved by the first computer server 3 will not be relevant to all users 2; therefore there is a filtering unit 9 that filters the information. The filtering may be based on predetermined criteria in the second computer server 6. For example, the second computer server 6 may filter out and discard all information not concerning the item in question, wherein which item is in question is provided by the mobile device 7. The second computer server 6 may filter out all information not specifically desired by the user, based on predetermined input settings into the mobile device 7 by the user 2. The second computer server 6 may filter out all information regarding which member 5 of the social network 4 inputted what information, thereby providing user discretion. When using a second server 6 which filters data retrieved by the first server 3, user discretion may be provided. Especially when handling user information regarding incontinence products for men and women many users will want to remain anonymous so the filtering of data is in order to provide for user discretion. By filtering the information, the most relevant information to send to the user can be selected and sent. When choosing between items in a store, user information regarding things such as an items use, quality, priceworthiness, a consumer rating of the item and user advice may be provided to the customer to help in deciding which product to buy.

The mobile device 7 of FIG. 1 comprises an image capturing device arranged for capturing at least one image or video sequence or live video feed representing a point of sale or location and is arranged for recognizing any occurrence of said desired item within said captured image or video sequence or live video feed. When a customer 2 uses his/her mobile device 7 to capture an image or a video of a shelf with products in a store, the mobile device 7 may provide information regarding the recognized items. In addition to receiving the information discussed above, the customer may obtain information regarding available alternatives in case an originally desired product is out of stock or if it is not available or if it cannot be found by the customer.

The mobile device 7 contains suitable software for recognizing whether the desired item is located within the field of scan of the image capturing device. This can be obtained through the use of image analysis of the captured image or video sequence, wherein the graphical representation of the item can be detected and identified by the software. If the item is identified, the software will preferably indicate this immediately to the user 2 of the mobile device 7, by including suitable information on a display of the mobile device 7. A notification of the existence of an alternative item can be followed by an indication of the actual location of the alternative item within the point of sale, that is, if the product is actually in stock and exists within the point of sale. It should be noted here that the disclosure is not limited to a system and method in which the information regarding said images and video recordings are stored in the mobile device 7 only, but can also be implemented in a manner in which the captured images and video sequences are transmitted to a remote computer (not shown in the drawings) for further analysis remote from the mobile device 7 and the user 2. The alternative items may also be items not available in the store but simply alternatives to the desired item. It should be noted that the captured image or video sequence as mentioned above could be in the form of one or more single images, a recorded video sequence or a live video feed, i.e. a live streaming video sequence.

The alternative items may be determined to be “alternatives” to the originally desired item based on one or more criteria. For example, they may be selected as alternatives based on the fact that they belong to the same type of products, that they are priced in generally the same price range as the originally desired item or that they originate from the same producer as the originally desired product. Other criteria are also possible within the scope of the disclosure.

The system 1 of FIG. 1 may further comprise that the filtering unit 9 is arranged for said filtering based on a predetermined set of criteria related to the desired item. The predetermined set of criteria may be predetermined in the second server 6 or in the mobile device 7. Predetermined criteria from the mobile device 7 may be inputted by the user 2 when the user 2 is setting up which information he/she finds most interesting. The predetermined set of criteria may include at least one of the following: social networking information comprising feedback and opinions from said members 5 relating to said desired item; categories or groups of products in which said item can be classified; points of sale or locations at which said desired item can be purchased by the user 2; information regarding the availability of said desired item at said points of sale or locations; information regarding criteria relating to said desired item such as its price, its manufacturer, product type, usage, size, colour, features or similar; and information regarding products which are alternative items to said desired item. When having a filtering unit user discretion may be ensured, as discussed above. Since the user also may predetermine what kind of information is considered most interesting, the information provided to the user is customized.

The user may select which criteria are to be used in order to determine which item or items are to be termed as “alternative items”. For example, the user may input information instructing the mobile device 7 to use “item price” as a decisive criterion. This means that, in case the originally desired item is not found, the mobile device 7 will present one or more alternative items (of the same product type) which are in generally the same price range as the originally desired item. According to another example, the user may select “manufacturer” as the decisive criterion. This means that, in case the originally desired item is not found, the mobile device 7 will present one or more alternative items (of the same product type) which are from the same manufacturer as the originally desired item. Generally, it can be noted that the user may select one or several criteria which are decisive for determining which products are to be selected as being “alternative items”, simplifying the item choice making.

The memory unit 8 of FIG. 1 may comprise a vendor database comprising information relating to said points of sale or locations and the availability of the desired item. The vendor database may be updated regularly by having the system 1 access the database which the vendor keeps over their stock. Alternatively, the vendor may send regular updates to the system 1 to update the vendor database in the memory unit 8. When having a vendor database with information it may be possible for a user to check the availability of a product before actually going to the store or sales location. The user 2 may also be informed by the second server 6 of the system 1 before going to the store whether there are any suitable alternatives if the desired item is not available. Another advantage with a vendor database is that the information sent to the user 2 may be complemented with information regarding products directly from the vendor, such as the price of the item at that vendor or information about ongoing campaigns with that item or suitable alternative items.

The mobile device 7 may be arranged for allowing input of user information in the form of a shopping list comprising a plurality of desired items. Such a shopping list may be used by the user 2 when going shopping and it may also be sent to and used by the filtering unit 9 when deciding what information to send back to the mobile device 7. The shopping list may be inputted by the user 2 into the mobile device 7 before going to a store. The user 2 may then receive information via the mobile device 7 from the second computer server 6 before going to the store about for example what items are available and/or to what price and/or if there are any alternative items and/or if available alternative items are offered at a better price than the item on the shopping list. When the user 2 is in a store and captures an image or video of a point of sale, the system 1 may prioritise providing information about the items which are found both in the captured image or video and on the shopping list.

The mobile device 7 of FIG. 1 may comprise a display arranged for presenting the product-related information. The user 2 will then be able to see the information as soon as the mobile device 7 receives it. The user 2 may then base his/her choice of item on the information presented on the display. The product-related information may be presented on the display with text or with a graphical representation. For example, when presenting the prices of an item and alternative items the information may be presented in a graph for making it easy to compare the prices. The mobile device 7 may show a user interface on the display where the product-related information is presented and where the user 2 may input information and instructions, such as the shopping list or which product-related information the user 2 is most interested in.

The mobile device 7 of FIG. 1 may be arranged for presenting information related to the location of the desired item by superimposing a graphical representation of information related to the location of said desired item onto the displayed image or video sequence on said display. To superimpose images is a method known to the person skilled in the art and will not be explained further here. By using the method to superimpose a graphical representation onto the image or video sequence of the point of sale, an image or video sequence is provided where it is easy for the user 2 to locate the desired item in the point of sale by comparing the image/video to the real life point of sale. For example, the software in the mobile device 7 may be arranged so that the desired item is shown having its outline or contour shown in a suitable colour, for example red. In this manner, the item in question can be easily detected on the display. The user 2 may use the mobile device 7 to sweep along the point of sale as if to “search for” a particular desired item. In other words, the user 2 will direct the mobile device 7 towards a position on a shelf or towards a section of the point of sale where the particular desired item can be expected to be found and take several images or a video sequence of the location. If the item is found, or an alternative item is found, it may be marked directly in the captured image or video sequence. If a user 2 who has inputted a shopping list into the mobile device 7 uses the mobile device 7 to sweep the point of sale in the supermarket, the mobile device 7 will recognize and show on the display any item from such a shopping list. In this case, the mobile device 7 is arranged for finding more than one product simultaneously.

In case any one of the desired items is not recognized by the mobile device 7, the software may propose alternative items. It should be noted that information regarding the exact position of the item is not required, just information regarding the location of the item in relation to the mobile device 7. The information relating to the location of the item may also be in the form of aural information such as for example sound effects or spoken messages or in the form of tactile or some other type of information indicated by physical means such as vibrations, or a combination of visual, aural, tactile or other physical information. This may be useful for example to a user which is blind and needs help in locating and choosing items in stores.

The disclosure is not limited to the above-mentioned image recognition only, but can be realized in alternative ways, for example through the use of NFC (Near Field Recognition) tags, transponders, QR codes or other devices or markings which allow the mobile device 7 with its image capturing device to determine the location of the item in question and to present information related to said location to a user 2.

Furthermore, the disclosure may be arranged so that the user 2 makes a selection of one or more desired items after the actual image or video has been captured and image recognition has been concluded. For example, the user 2 may instruct the mobile device 7 to capture an image or video sequence of a particular point of sale where it can be expected that a number of products, which may or may not be of interest to the user 2, are located. If and when the mobile device 7 recognizes the occurrence of one or more items, information relating to these products is shown on the display and the user 2 may then decide which items are of particular interest.

The mobile device 7 of FIG. 1 may be arranged for recognizing the occurrence of the desired item through the use of a recognition graphic in the form of a design, print, marking, code or similar applied to the item or its packaging. Graphic recognition algorithms are known to the person skilled in the art and will not be explained further. Several things may be used to recognize an item. The mobile device 7 may try to recognize items by trying several different recognition graphics. If, for example, the recognition graphic recognizing specific design fails, recognition by a specific code may work to recognize it. It may then be possible to recognize items even if they are partly hidden; i.e. only part of the item must be visible. The mobile device 7 may be adapted to recognize the entire item or a part thereof.

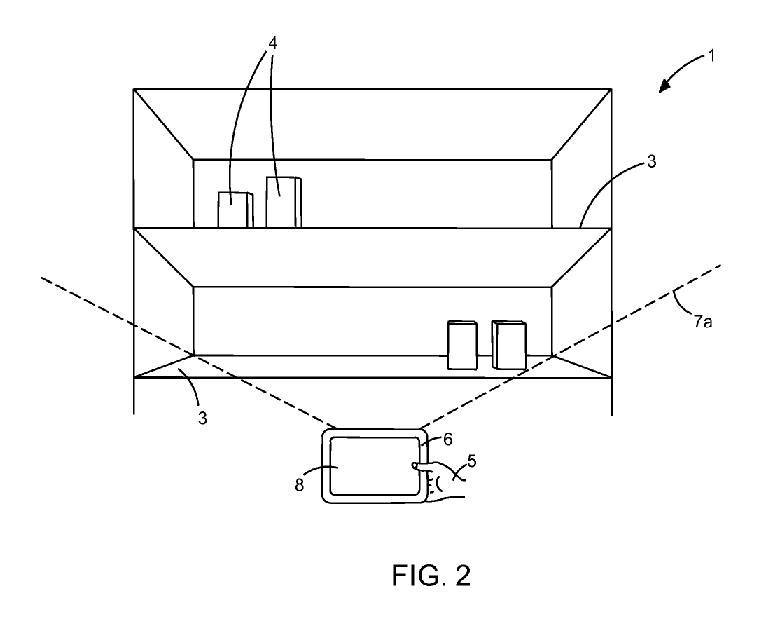

FIG. 2 illustrates a method for providing product-related information to a user regarding at least one desired item. The item is a hygiene article, such as a male or female incontinence protector, a sanitary pad, a diaper with tape fastener, a pant diaper or a belted diaper; a lotion, wipe or towel. The method comprises the steps of:
Connecting 11 the first computer server to at least one social network for providing social networking information, in the form of feedback and opinions related to said item, from members of said social network. The first computer server 3 may be connected to the at least one social network 4 via internet. The first computer server 3 may collect the social networking information from the at least one social network 4 via internet by connecting to the servers of the at least one social network 4 and downloading the information. The information may be sent to the first computer server 3 by the providers of the at least one social network 4. In social networks 4 it may be possible for members 5 of the network 4 to express opinions and experiences about certain products. It may also be possible for members 5 to rate products. The social network information may comprise opinions related to the item. The social network information may comprise ratings of the item by members 5. The social network information may comprise usage experiences of the item. The social network information may comprise tips regarding the item. The social network may be any kind of social network, such as a member forum for a specific topic. Such a forum may for example be the Global Forum on Incontinence.
Connecting 12 the second computer server to at least one mobile device arranged for entering information identifying said desired item and arranged for presenting said product-related information to said user. The second computer server exchanges data with the mobile device with for example the IP (Internet Protocol). The second computer server is connected to the mobile device to provide it with the information obtained in the first computer server. The mobile device may also provide the second computer server with what information the user wants and regarding what items.
Storing 13 the social networking information in the memory unit. When storing the information, there is no need for the first server to collect the social network information over and over again when a mobile device requests the information. The first server only needs to collect updates to the information from the at least one social network.
Providing 14 access to said memory unit by the first server and the second server. Since the first server and the second server and the memory unit are all part of the computer based system of FIG. 1, they are part of the same unit and may be connected directly to each other. The memory unit may be any type of memory, for example a RAM, a flash memory, a ROM or any type of memory capable of storing data.
Capturing at least one image or video sequence or live video feed representing a point of sale or location by means of an image capturing device in said mobile device. When a customer/user uses his/her mobile device to capture an image or a video of a shelf with products in a store, the mobile device may use recognizing software to identify the items in the image/video.
Recognizing any occurrence of said desired item within said captured image or video sequence or live video feed. The mobile device may use image recognition software for recognizing the occurrence of said desired item or alternative items to said desired item. The mobile device may provide information regarding the recognized items to the second computer server.
Filtering data retrieved by said first server in a filtering unit forming part of said second server. The filtering unit may be arranged for filtering data retrieved by said first server in order to supply said product-related information to said mobile device. All social network information retrieved by the first computer server will not be relevant to all users; therefore there is a filtering unit that filters the information. The filtering may be based on predetermined criteria in the second computer server. For example, the second computer server may filter out and discard all information not concerning the item in question, wherein which item is in question is provided by the mobile device. The second computer server may filter out all information not specifically desired by the user, which information the user predetermines by inputting settings into the mobile device. The second computer server may filter out all information regarding which member of the social network inputted what information so as to provide user discretion. When having a second server which filters data retrieved by the first server, user discretion may be provided. Especially when handling user information regarding incontinence products for men and women many users will want to remain anonymous so the filtering of data is in order to provide for user discretion. By filtering the information, the most relevant information to send to the user can be selected and sent.
Supplying said product-related information to said mobile device. In addition to receiving the information discussed above, the customer may obtain information regarding available alternatives in case an originally desired product is out of stock or if it is not available or if it cannot be found by the customer. When choosing between items in a store, user information regarding things such as an items use, quality, priceworthiness, a consumer rating of the item and user advice may be provided to the customer to help in deciding which product to buy.

Since the method comprises capturing an image or a video representing a point of sale and recognizing any occurrence of said desired item within said captured image or video sequence or live video feed when a customer uses his/her mobile device to capture an image or a video of a shelf with products in a store, the mobile device may provide product-related information regarding the recognized items. The customer/user may also obtain information regarding available alternatives, which alternatives may also been recognized in the captured image or video sequence, in case an originally desired product is out of stock or if it is not available or if it cannot be found by the user.

The method of FIG. 2 may further comprise that the step of filtering is based on a predetermined set of criteria related to the desired item. The predetermined set of criteria may be predetermined in the second server 6 or in the mobile device. Predetermined criteria from the mobile device may be inputted by the user when the user is setting up which information he/she finds most interesting. The predetermined set of criteria may include at least one of the following: social networking information comprising feedback and opinions from said members relating to said desired item; categories or groups of products in which said item can be classified; points of sale or locations at which said desired item can be purchased by the user; information regarding the availability of said desired item at said points of sale or locations; information regarding criteria relating to said desired item such as its price, its manufacturer, product type, usage, size, colour, features or similar; and information regarding products which are alternatives to said desired item.

An effect of filtering based on a predetermined set of criteria related to the desired item is, as discussed above, that user discretion may be ensured. Another advantage is that the user may predetermine what kind of information is considered most interesting and thus the information provided to the user is customized.

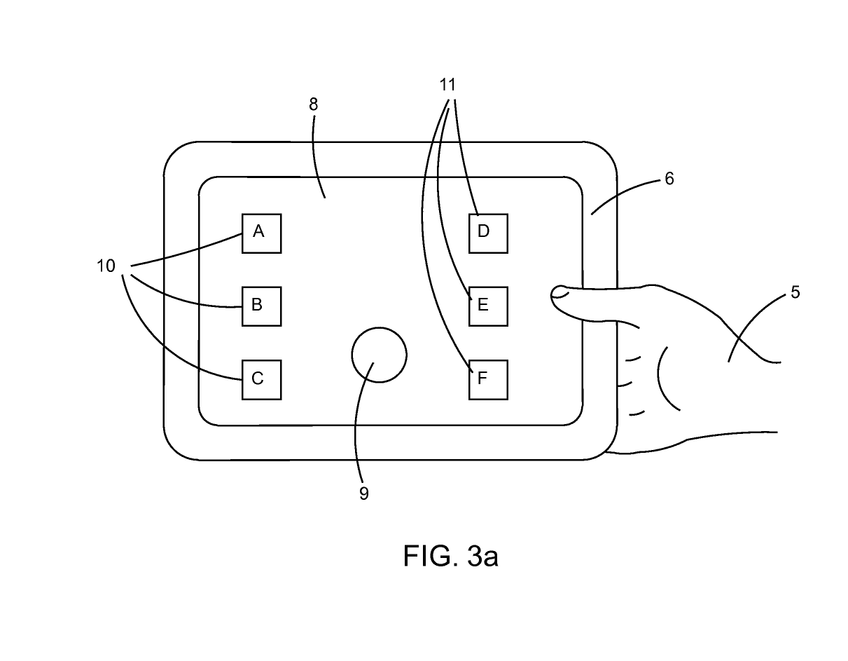

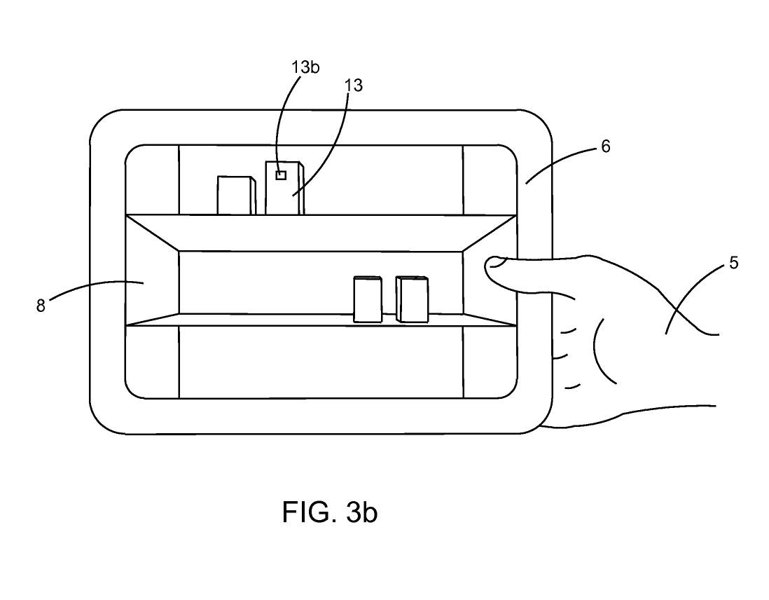

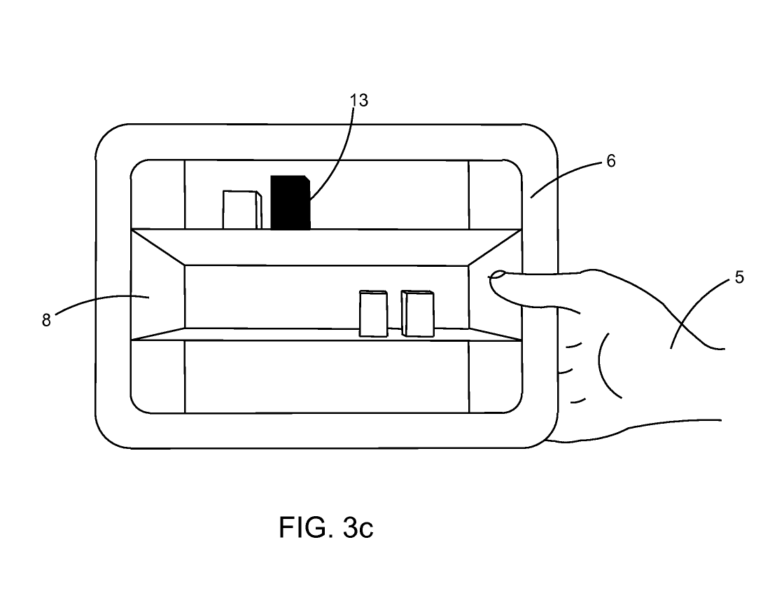

According to FIG. 3, the method of FIG. 2 may further comprise, at the dashed line, providing 19 information relating to said points of sale or locations and the availability of the desired item via a vendor database forming part of said memory unit. The vendor database may be updated regularly by having the system access the database which the vendor keeps over their stock. Alternatively, the vendor may send regular updates to the system to update the vendor database in the memory unit. When having a vendor database with information it may be possible for a user to check the availability of a product before actually going to the store or sales location. The user may also be informed by the second server of the system before going to the store whether there are any suitable alternatives if the desired item is not available. Another advantage with having a vendor database is that the information sent to the user may be complimented with information regarding products directly from the vendor, such as the price of the item at that specific vendor or information about ongoing campaigns with that item or suitable alternative items.

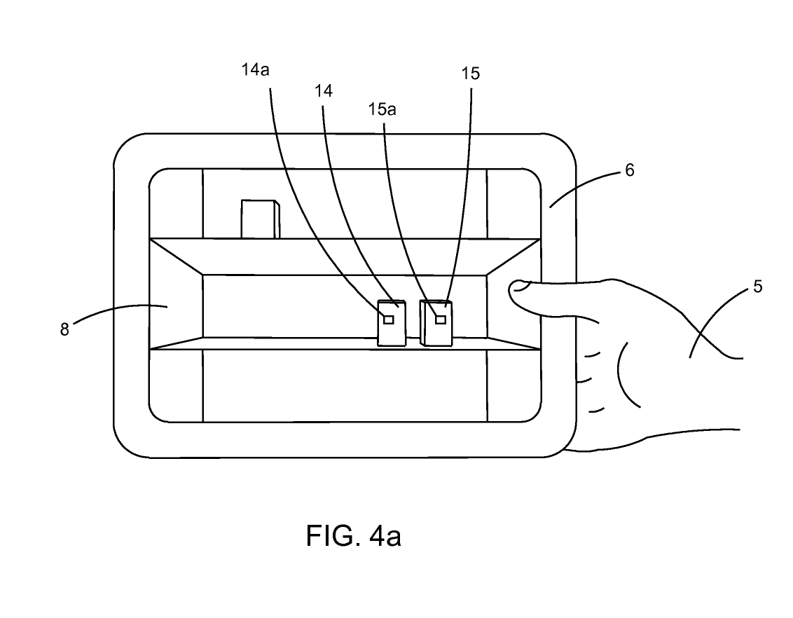

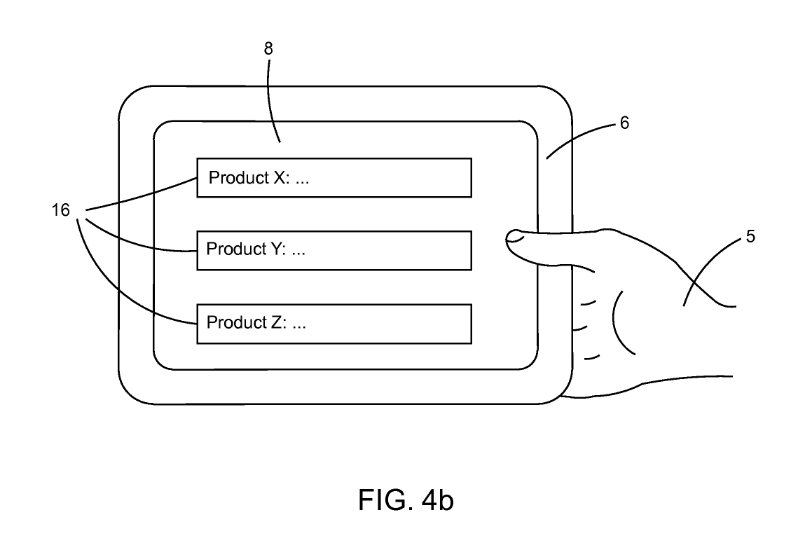

According to FIG. 4, the method of FIG. 2 may further comprise, at the dashed line, presenting 20 said product-related information on a display forming part of said mobile device 7. The user will then be able to see the information as soon as the mobile device receives it. The user may then base his/her choice of item on the information presented on the display. The product-related information may be presented on the display with text or with a graphical representation. For example, when presenting the prices of an item and alternative items the information may be presented in a graph for making it easy to compare the prices.

According to FIG. 5, the method of FIG. 2 may further comprise, at the dashed line, presenting 21 information related to the location of said desired item, by superimposing a graphical representation of information related to the location of said desired item onto the displayed image or video sequence on said display. To superimpose images is a method known to the person skilled in the art and will not be explained further here. By using the method to superimpose a graphical representation onto the image or video sequence of the point of sale, an image or video sequence is provided where it is easy for the user to locate the desired item in the point of sale by comparing the image/video to the real life point of sale; it will be easy for the user do see and interpret the information on his/her display. The software in the mobile device 7 may for example be arranged so that the desired item is shown having its outline or contour shown in a suitable colour, for example red. In this manner, the item in question can be easily detected on the display. It should be noted that information regarding the exact position of the item is not required, just information regarding the location of the item in relation to the mobile device. The information relating to the location of the item may also be in the form of aural information such as for example sound effects or spoken messages or in the form of tactile or some other type of information indicated by physical means such as vibrations, or a combination of visual, aural, tactile or other physical information.

According to FIG. 6, the method of FIG. 2 may further comprise, at the dashed line, recognizing 22 the occurrence of the desired item through the use of a recognition graphic in the form of a design, print, marking, code or similar applied to the item or its packaging. Graphic recognition algorithms are known to the person skilled in the art and will not be explained further. Several things may be used to recognize an item. The mobile device may try to recognize items by trying several different recognition graphics. If, for example, the recognition graphic recognizing specific design fails, recognition by a specific code may work to recognize it. It may then be possible to recognize items even if they are partly hidden; i.e. only part of the item must be visible.

A computer program for providing product-related information to a user regarding at least one desired item is provided. The computer program comprises that when it is executed by a processor, it causes a computer system comprising a first server, a second server and a mobile device to perform the method according to FIGS. 2-6 above. A computer program which performs the method according to above can be installed and used on mobile devices. Mobile devices are easy for the users/customers to bring anywhere and most people always have at least one mobile device with them. Preferably, the computer program is realised in form of a stand-alone application, meaning that no data has to be received from external devices in order to run the program. However, the computer program may also be a client application of a distributed software solution further comprising a server-side application residing in an application server to which the mobile device is communicatively connectable. In this case, some of the method steps described above may be performed by the application server through execution of the server-side application.

In a preferred embodiment of the disclosure, the computer program which may be stored on the mobile device 7 is realised in form of an App (or “application program”) which is downloadable into the storage medium from a downloading server to which the mobile device 7 is connectable. The App is preferably adapted to the Apple iOS platform and/or the Android platform and distributed through known distribution channels. The App can be executed by means of a suitable user input, for example in the form of a particular icon on the display of the mobile device 7 which the user touches and which corresponds to a “start button” for the App. The user may predetermine what product-related information he/she wants by inputting settings into the App in the mobile device 7. For example, a series of icons in the App may represent particular product categories, for example incontinence pads, which the user may choose from. The App may furthermore be arranged for allowing the user to select an item from a further product category, for example baby diapers. For this reason, the App according to the disclosure can be arranged to present a second series of icons on the display corresponding to said further product category. The user may then select between different items representing different product types. The user may also input a shopping list directly into the App which is used when the App sends information to the second computer server about what information the user is interested in. The App is suitably arranged to be downloadable to a storage medium of the mobile device 7. By allowing the method to be performed through the execution of an App that may be downloaded into existing mobile devices 7, the method becomes readily available to any user 2.

A mobile device 7 according to FIG. 7 is provided for providing product-related information to a user regarding at least one desired item. The mobile device 7 comprises a processor 23 and a storage medium 24 for storing computer programs executable by said processor 23. The processor 23 and the storage medium 24 may be located anywhere in the mobile device 7. The mobile device 7 may also comprise of an image capturing device 25. An image capturing devices 25 is generally known and typically comprises an image sensor and a lens (not shown) which are used for example in mobile devices for capturing photographic images and video sequences. The image capturing device 25 may also be placed on the back side of the mobile device 7. The image capturing device 25 may also be placed anywhere on the mobile device 7. Preferably, the image capturing device 25 is in the form of a camera. Preferably, the image capturing device is a camera 25 which is sensitive enough to register images and video sequences of relatively high resolution. With high resolution it is easier for the recognizing software to identify items in the captured image or video sequence. The mobile device may also comprise a display 26. The mobile device may further comprise that it is arranged for operating in accordance with a computer program as defined above. When having a mobile device 7 arranged to operate in accordance with a computer program as defined above, the method according to FIGS. 2-6 may be used anywhere with a mobile device. The method is made accessible to all users with a mobile device. The mobile device 7 may also comprise means for receiving user input, such as the display being a touch sensitive display, buttons, microphones, as well as means for outputting signals and information, such as for example a loudspeaker, a vibratory device etc. By using output information in the form of sound and vibrations, users who are blind may make use of the disclosure to receive product-related information and help in the choice making when choosing between products. Such additional devices are generally known and for this reason they are not explained in detail here.

FIG. 8 shows an example of an image that has been captured by a mobile device 7 and is shown on the display of the mobile device 7. The image is of a point of sale in a store and comprises shelves and 4 items.

FIG. 9 shows the same image as in FIG. 8 but when a desired item or an alternative item has been graphically marked in the image by the system according to the disclosure as described above. By marking the item in a clear manner it is easy for a user to spot which item/items in the point of sale is/are of interest.

The mobile device 7 preferably comprises a light source (not shown in the drawings) which can be a conventional flash-type light device as used in many of today's mobile devices such as mobile telephones. The light source is arranged for generating a field of light (not shown in the drawings) directed from the mobile device 7. Alternatively, the disclosure could be used with a separate light source or with natural ambient light only, if the light conditions are sufficient. The disclosure may suitably comprise a step of illuminating the point of sale with an integrated light source of the mobile device 7 during the image capturing.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present disclosure. However, the disclosure should be regarded as illustrative rather than restrictive, and not as being limited to the particular embodiments discussed above. The different features of the various embodiments of the disclosure can be combined in other combinations than those explicitly described. It should therefore be appreciated that variations may be made in those embodiments by those skilled in the art without departing from the scope of the present disclosure as defined by the following claims.

1. A computer-based system for providing product-related information to a user regarding at least one item, wherein the item is a hygiene article, the system comprising:
a first computer server that is configured to connect to at least one social network for providing social networking information, in the form of feedback and opinions related to said item, from members of said social network,
a second computer server that is configured to connect to at least one mobile device arranged for entering information identifying said item and arranged for presenting said product-related information to said user;
a memory unit arranged for storing said social networking information and arranged to be accessed by the first server and the second server;
wherein said second server comprises a filtering unit arranged for filtering data retrieved by said first server in order to supply said product-related information to said mobile device and wherein said mobile device comprises an image capturing device arranged for capturing at least one image or video sequence or live video feed and arranged for recognizing any occurrence of said item within said captured image or video sequence or live video feed via a software detection of a graphical representation of the item.

2. The system according to claim 1, wherein the filtering unit is arranged for said filtering based on a predetermined set of criteria related to the item, the criteria including at least one of the following:
social networking information comprising feedback and opinions from said members relating to said item;
categories or groups of products in which said item can be classified;
points of sale or locations at which said item can be purchased by the user;
information regarding availability of said item at said points of sale or locations;
information regarding criteria relating to said item; and
information regarding products which are alternatives to said item.

3. The system according to claim 2, wherein said filtering unit is further arranged for filtering out information related to which members of said social networks that have provided said social networking information.

4. The system according to claim 1, wherein said memory unit comprises a vendor database comprising information relating to said points of sale or locations and the availability of the item.

5. The system according to claim 1, wherein the mobile device is arranged for allowing input of user information in the form of a shopping list comprising a plurality of items.

6. The system according to claim 1, wherein said mobile device comprises a display arranged for presenting said product-related information.

7. The system according to claim 1, wherein said mobile device is arranged for presenting information related to the location of said item by superimposing a graphical representation of information related to the location of said item onto the displayed image or video sequence on said display.

8. The system according to claim 1, wherein the mobile device is arranged for recognizing the occurrence of the item through a recognition graphic in the form of a design, print, marking, or code applied to the item or its packaging.

9. A method for providing product-related information to a user regarding at least one item, wherein the item is a hygiene article, said method comprising:
connecting a first computer server to at least one social network for providing social networking information, in the form of feedback and opinions related to said item, from members of said social network;
connecting a second computer server to at least one mobile device arranged for entering information identifying said item and arranged for presenting said product-related information to said user;
storing said social networking information in a memory unit; and
providing access to said memory unit by the first server and the second server;
wherein said method further comprises:
capturing at least one image or video sequence or live video feed by means of an image capturing device in said mobile device;
recognizing any occurrence of said item within said captured image or video sequence or live video feed via a software detection of a graphical representation of the item;
filtering data retrieved by said first server in a filtering unit forming part of said second server; and
supplying said product-related information to said mobile device.

10. The method according to claim 9, wherein the method comprises filtering based on a predetermined set of criteria related to the item, including at least one of the following:
social networking information comprising feedback and opinions from said members relating to said item;
categories or groups of products in which said item can be classified;
points of sale or locations at which said item can be purchased by the user;
information regarding availability of said item at said points of sale or locations;
information regarding criteria relating to said item; and
information regarding products which are alternatives to said item.

11. The method according to claim 10, wherein the method further comprises filtering out information related to which members of said social networks that have provided said social networking information.

12. The method according to claim 9, wherein the method comprises providing information relating to said points of sale or locations and the availability of the item via a vendor database forming part of said memory unit.

13. The method according to claim 9, wherein the method comprises presenting said product-related information on a display forming part of said mobile device.

14. The method according to claim 13, wherein the method comprises presenting information related to the location of said item, by superimposing a graphical representation of information related to the location of said item onto the displayed image or video sequence on said display.

15. The method according to claim 9, wherein the method comprises recognizing the occurrence of the item through the use of a recognition graphic in the form of a design, print, marking, or code applied to the item or its packaging.

16. (canceled)

17. A mobile device for providing product-related information to a user regarding at least one item, wherein the item is a hygiene article, the mobile device comprising a processor and a storage medium encoded with a computer programs executable by said processor, the computer program causing a computer system comprising a first computer server, a second computer server and the mobile device to provide product-related information to said user regarding said item, by:
connecting said first server to at least one social network for providing social networking information, in the form of feedback and opinions related to said item, from members of said social network;
connecting said second server to said mobile device arranged for entering information identifying said item and arranged for presenting said product-related information to said user;
storing said social networking information in a memory unit;
providing access to said memory unit by the first server and the second server;
capturing at least one image or video sequence or live video feed by means of an image capturing device in said mobile device;
recognizing any occurrence of said item within said captured image or video sequence or live video feed via a software detection of a graphical representation of the item;
filtering data retrieved by said first server in a filtering unit forming part of said second server; and
supplying said product-related information to said mobile device,
wherein the filtering is based on a predetermined set of criteria related to the item, including at least one of the following:
social networking information comprising feedback and opinions from said members relating to said item;
categories or groups of products in which said item can be classified;
points of sale or locations at which said item can be purchased by the user;
information regarding availability of said item at said points of sale or locations;
information regarding criteria relating to said item; and
information regarding products which are alternatives to said item.

18. The mobile device according to claim 17, wherein the mobile device is a tablet computer, a mobile phone, a personal digital assistant (PDA), a smartphone, or a wearable mobile device.

19. The system according to claim 1, wherein the hygiene article is a male or female incontinence protector, a sanitary pad, a diaper with tape fastener, a pant diaper or a belted diaper, a lotion, wipe or towel.

20. The system according to claim 2, wherein the information regarding criteria relating to said item comprises price, manufacturer, product type, usage, size, or colour.
